(19) United States
(12) Patent Application Publication
(10) Pub. No.: US 2011/0231010 A1
(43) Pub. Date: Sep. 22, 2011

(54) Pill counting and control system for a pill transport apparatus

(76) Inventors: Richard Panetta, Milton (CA); Derek Bessette, Milton (CA)

(21) Appl. No.: 12/728,204

(22) Filed: Mar. 20, 2010

(51) Int. Cl. G06F 17/00; G06M 7/00

(52) U.S. Cl. 700/236; 377/6

(57) ABSTRACT

The present invention provides a method and apparatus for dispensing varying quantities of pills quickly, conveniently, securely, accurately operable to incorporate one or more sensors and at least two data sets for the purpose of monitoring the activity of transferring pills from a pill singulation to a bottle. For example, a counting means may be operable, in real-time or near-real time, to count the pills transferred to a bottle. A sensor array data-acquisition means may be utilized to facilitate the collection and monitoring of data relating to transfer of pills to a bottle. The counting means and sensor array data-acquisition means may be applied in a cooperative manner so as to facilitate examinations for the purpose of identifying pill events, such as overlapping pill dispensing, that have the potential to invalidate the counting means results.

### FIELD OF INVENTION

The present invention relates to a method and apparatus for counting items moving as a closely arranged sequence thereof. The invention has a particular application for counting pills being dispensed at a medicament dispensary kiosk.

### BACKGROUND OF THE INVENTION

In this specification, the term “medicament” encompasses drugs and any and all other materials dispensed subject to presentation of a prescription, and the term “pill” encompasses pills, capsules, lozenges and like discrete items intended for ingestion.

The traditional means of dispensing prescribed medicaments involves a doctor meeting with a patient and prescribing a medicament based on a particular diagnosis, and then hand writing and signing a prescription of the patient to carry to a pharmacist at a pharmacy location for fulfillment. In recent years, two significant advances have occurred in the field of medicament dispensing. The first is the advent of electronic prescription capturing methods, systems and apparatus, which improve the overall accuracy and patient record-keeping associated with prescribing drugs. The second is the advent of automated apparatus, typically configured as kiosks, from which medicaments can be automatically dispensed, the kiosks being located for convenient patient access, such as at a doctor's premises, a hospital or mall, and being networked with a system server for inventory control and management. In this regard, reference may be made to applicant's co-pending PCT application serial no. PCT/CA2007/001220 related to a method, system and apparatus for dispensing drugs.

More specifically, the PCT application describes a networked system having a server, a database of patient information linked to the server, a first client device having input means linked to the server and operable to generate a script for a medicament prescribed to a user, and a second client device comprising an automated apparatus for dispensing medicaments (referred to in said PCT application as a robotic prescription dispensary) operable to recognize a human and/or machine readable description in the script, and to provide validating cross-referencing between the description and patient information as a prelude to dispensing a drug to the user on the basis of the input script. A doctor in a clinic can be associated with a third client device having input means linked to the server to input appropriate prescription information, or accept certain prescription information from the database as being applicable in the particular case for a particular patient. Further, the doctor's client device can be operable to display patient information, e.g., drug history, insurance coverage, etc., and a printer module can print the script as a paper print-out.

The server and database enable storing, compiling and retrieval of patient data including name, address, and diagnostic and drug history. Access to the database can be provided to both the doctor and the automated apparatus for dispensing medicaments via the server, via a secure connection, or via a link between the system and a clinic's existing clinic management system or patient database.

The system described in PCT/CA2007/001220 has a user interface for receiving input data from the user and for guiding the user through a medicament dispensing procedure. The system also has a teleconferencing or video-conferencing means enabling communication between the user and a human validation agent, such as a licensed pharmacist, who may be connected to the system from a remote location. The user interface also includes a scanning means for capturing an image of the script for validation by the validation agent.

An authentication means for confirming the identity of the user may, for example, prompt the user for a personal identification number, to provide biometric identifying data, or to provide answers to questions that will identify the user when cross-referenced with patient information stored on the networked database. Once the user is recognized, the dispensary apparatus prompts the user for, a script and the apparatus processes the script either by the above-mentioned human validation agent or by processing the machine readable description, which may be a bar code. This information can be verified with the server and the database. The apparatus may also interface with the server for the adjudication of insurance claims and for determining amounts to be paid by patients. The patient either accepts or rejects the transaction. If the transaction is accepted, the apparatus interfaces with the server in effecting a payment transaction, for example, by prompting the patient for credit card information. Prescription labels and receipts are printed. The apparatus confirms that the drug is correct and delivers it to a dispensing area for retrieval by the user while retaining the script in a lock box, and verifying that the purchased drug product has been retrieved. Further, the apparatus may print and/or provide to the user educational materials relevant to the medicaments that have been dispensed. The medicament dispensary kiosk may be located in a doctor's office or clinic. The interaction between a user and the user interface coupled with access to the various networked functionalities means that a patient can obtain prescribed medicaments without having to attend a pharmacy or drug store.

In a further copending patent application PCT/CA2009/001186 ('186), a particular medicament dispensary apparatus for delivering medicaments to users is disclosed, the apparatus having a drug vault with a pre-packaged product storage container for containing inventory pre-packaged medicament product and a bulk product storage container for containing inventory medicament in bulk form, including to maximize the medicaments that can be stored within the space made available in the kiosk.

The apparatus disclosed in '186 has a control system operable to dispense bulk form inventory medicament from the bulk product storage container, to package the medicament as a suitable package, and to pick and deliver the package to a delivery zone of the kiosk. One form of bulk products is pills. In a medicament dispensary kiosk of the type contemplated, an efficient method and apparatus for dispensing pills is required. In order to reduce wait times for dispense of medicaments, and manage operation of the medicament dispensary kiosk efficiently, a relatively short medicament dispense cycle is required, while ensuring that pill counts are accurate, including to meet regulatory requirements.

It is noted that some government regulations require that certain classes of medicaments be double-counted.

Whether for a medicament dispensary kiosk or for other application where pill counting is required, such as packaging of medicaments in containers whether by a drug manufacturer, distributor, or pharmacy, there is a need for a pill counting apparatus, and control system for a pill transport apparatus linked to the pill counting apparatus, that provides efficient and accurate pill counting in batches of medicaments of different sizes, and also for medicaments that vary in their size and shape.

### SUMMARY OF THE INVENTION

According to one aspect of the invention, there is provided a method for counting items moving as a closely arranged series thereof, the method comprising directing the items of the closely arranged series past at least one sensor to generate a sequence of energy pulses corresponding to the passage of successive ones of the items past the at least one sensor, analyzing the sequence of pulses to generate a first count, deriving pulse width data from the sequence of pulses, comparing the pulse width data against reference data related to prior valid counts of other items to derive a second count, and determining a valid count exists if the first count matches the second count.

According to another aspect of the invention, a method for the delivery of individually prescribed amounts of one or more pill medicaments from a pill dispenser is provided comprising of the steps of: (a) receiving input by the pill dispenser regarding desired pill types and quantities; (b) allowing a control system to determine logic requirements for the dispensing of pills; (c) delivering of pills to a pill singulator, comprising of: (i) a tray for supporting pills; (ii) a drive means that is operable to move the pills in a stream that is of one pill in width; and (iii) a guide to guide to establish spacing between the driven pills and to guide the driven pills into a container; (d) counting the number of pills being driven into the container by gathering sensor data from at least one sensor disposed adjacent to the opening of the container, and analyzing such sensor data so as to establish a primary pill count and a secondary validated pill count derived from the pill count; and (d) authorizing dispensing of the one or more pills to the user if the analysis of the sensor data generates a successful comparison result between the desired pill quantity and the primary pill count and the secondary validated pill count.

According to a further aspect of the invention, there is provided a system for counting items, the system comprising a drive to move the items as a closely arranged series, at least one sensor to detect passage of the items past the at least one sensor and for generating a sequence of energy pulses corresponding to the passage of successive ones of the items past the at least one sensor, an analysis module to analyze the sequence of pulses to generate a first count, to derive pulse width data from the sequence of pulses, to compare the pulse width data against reference data related to prior valid counts of other items to derive a second count, and to determine a valid count exists if the first count matches the second count.

According to yet another aspect of the invention, a system for the delivery of individually prescribed amounts of one or more pill medicaments from a pill dispenser is provided, comprising: (a) a pill singulator, comprising of: (i) a tray for supporting pills; (ii) a drive means that is operable to move the pills in a stream that is of one pill in width; and (iii) a guide to guide the driven pills towards a pill receiving station and to establish spacing between the driven pills; and being operable to transfer the pills to a pill container; (b) a control system linked to the pill singulator for controlling the driving of pills by the pill singulator, including controlling the starting and stopping of the pill singulator, and the speed of the driving of pills by the pill singulator, and for determining the logic requirements for the dispensing of pills, including based on desired pill types and quantities; and (c) a counting system linked to the control system, for counting the number of pills being driven into the container by gathering sensor data from at least one sensor disposed adjacent to the opening of the container, and analyzing such sensor data so as to establish a primary pill count and a secondary validated pill count derived from the primary pill count; wherein the control system authorizes the dispensing of the one or more pills to the user if the analysis of the sensor data generates a successful comparison result between the desired pill quantity and the primary pill count and the secondary validated pill count.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1. is a perspective view of a pill dispensing module according to one embodiment of the invention, and illustrating a representative installation of the sensor array;

FIG. 2 is a schematic diagram of a system according to an embodiment of the invention.

FIG. 3 is a graph illustrating a time-gap distribution for a pill dispense or counting session.

FIG. 4 is a graph illustrating pulse width data in accordance with the present invention.

FIG. 5 is a graph illustrating data weighting reliability determined in accordance with the present invention, in a representative calculation thereof.

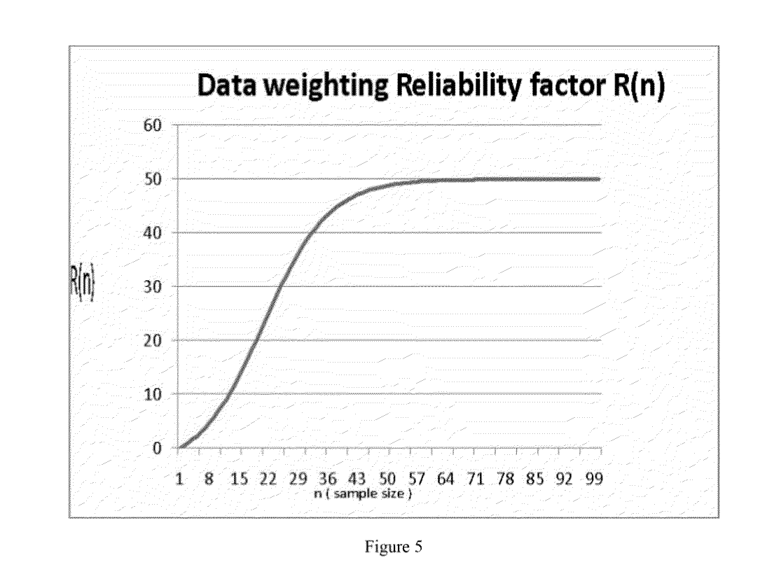

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention provides a method, system and apparatus for dispensing varying predetermined quantities of pills, in accordance with a medicament prescription, quickly, conveniently, securely, and accurately, including in a medicament dispensary kiosk.

In order to dispense varying predetermined quantities it is important to have a system, apparatus and/or method for counting pills accurately.

The present invention provides a control system, apparatus, and method for controlling the delivery of pills from a pill store to one or more containers. The control system is linked to a system or apparatus that delivers pills from a pill store to one or more containers, for controlling that system or apparatus in a manner described below.

Another aspect of the invention is a counting system, apparatus, and method that is suitable for counting pills but also for counting other objects delivered in sequence along a transport path where providing an accurate count is advantageous. The counting system and apparatus can be part of the control system and apparatus, or these are linked to one another. One aspect of the invention, is that based on operation of the counting system, means is provided for controlling a pill transport system or apparatus to reduce counting error or other operational aspects of the system.

The control system and apparatus and the counting system and apparatus may be part of a medicament dispensary kiosk or a pill counter used by any entity that packages medicaments, whether a drug manufacturer, distributor or pharmacy. The control system, apparatus, and method can be part of or linked to a pill counting system that singulates pills.

The disclosure refers to “medicaments”. In this disclosure, the term “medicament” encompasses drugs and any and all other materials dispensed subject to presentation of a prescription, and the term “pill” encompasses pills, capsules, lozenges and like discrete items intended for ingestion. The term “singulate” is used to refer to the process of organizing moving pills into a “stream” formation a single pill in width.

### Medicament Dispensary Kiosk

An example of a medicament dispensary kiosk in accordance with the present invention, that includes or is linked to the pill counting system and control system of the present invention, is described herein.

The medicament dispensary kiosk can include means for dispensing medicaments in pill form from a bulk pill store within the medicament dispensary kiosk, by counting a particular number of pills, and delivering the desired number of pills to a container, and closing the container, all by operation of the medicament dispensary kiosk.

In operation of a medicament dispensary kiosk, where the number of pills required in a single dispense session can vary significantly, it is advantageous to have a pill counting system, apparatus and method that provides accurate pill dispensing. It is also advantageous to provide a control system for controlling a pill transport system or apparatus that is part of a medicament dispensary kiosk, that is linked to the pill counting system so as to enable control of the pill transport system in a way that reduces errors in operation of the pill transport system.

In one aspect of the invention, the pill transport apparatus described includes or consists of a pill singulator apparatus for singulating the pills in the transport thereof so as to organize the pills into a stream. Pill singulation is often required to obtain an accurate pill count.

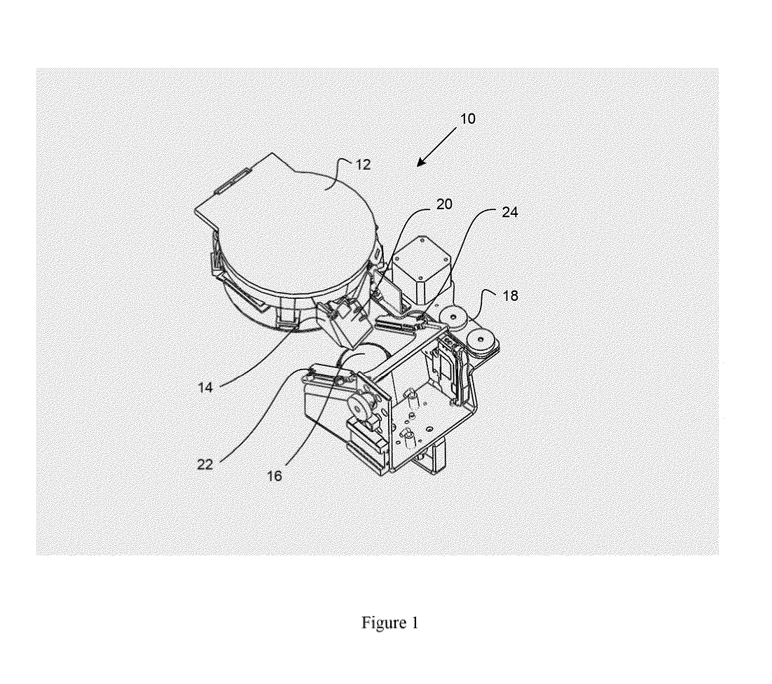

Referring to FIG. 1, a pill dispensing module (10) includes a pill hopper (12), and a chute (14) for directing pills toward an opening of a container (16). The pill dispensing module includes a container delivery mechanism 18 for placing a pill container below the chute (14) where it can receive pills falling from the chute, through a pill drop zone, and into the opening of the container 16.

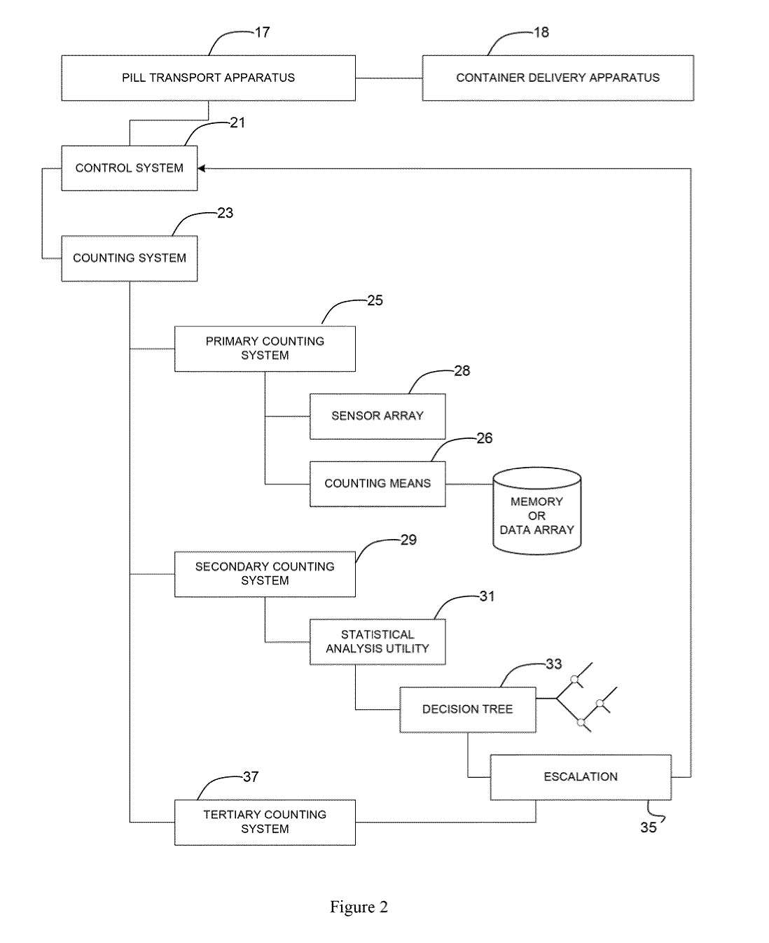

The system of the present invention, and the utilities that are part of such system, can be understood by reference to the description below and FIG. 2.

### Control System

The medicament dispensary kiosk includes a control system for controlling the delivery of pills through the pill drop zone into the pill container.

Referring to FIG. 2, a control system (21) includes means to cease the delivery of pills to a particular container, once the required number of pills for that container has been delivered to the container. For example, the medicament dispensary may further include a gate movable from a closed to an open position to permit singulated pills to drop into the opening of a container, such as a pill bottle, which opening is positioned to collect falling pills and where a sensing mechanism detects and counts the pills falling in the fall zone to enable the supply of pills from the hopper to be halted when a required number of pills have passed into the fall. FIG. 1 illustrates such a moveable gate (20).

The control system also includes means for varying the speed of delivery of pills, for example to reduce the speed of delivery of pills, nearing the total number of pills to be delivered as part of a particular dispense or counting session, which can help prevent too many pills being transported.

### Counting System

The control system is linked to a counting system or apparatus to establish when the required number of pills have been transported to the particular container, as determined based on the prescription of the applicable dispense. FIG. 2 is a system diagram illustrating, in one implementation of the invention, the components of the system of the present invention.

### Primary Counting Apparatus

The counting system or apparatus includes a primary counting system or apparatus (25). The primary counting system or apparatus may consist of a counter means or sensor data acquisition utility which is operable to generate or facilitate the generation of a count of the number of pills transported as part of a specific stream of pills (defined based on a particular dispense or counting session), transported at a relatively high speed by a pill transport apparatus such as the pill singulator apparatus shown in FIG. 1. The counter means can be implemented as an optical detector/emitter that acts as a transition counter and is typically associated with a micro-controller embedded application. One particular implementation of such a primary counting apparatus is illustrated in FIG. 1, wherein a emitter sensor array (22) is mounted in one area of the container delivery apparatus (18) adjacent to the pill drop zone, and a receiver sensor array (24) is mounted in an another area of the container delivery apparatus (18), opposite to the emitter sensor array (24), such that the emitter sensor array (22) and the receiver sensor array (24) define a sensor array area that covers as an area in the pill drop zone that covers the opening of any container that is delivered to pill drop zone by the container delivery apparatus (18). The delivery of a pill through the sensor array results in a state-date event that is captured by the counting means (26) or sensor data acquisition utility described below.

The sensor array (28) can include a plurality of fiber optic beams. The counter means (26) in one implementation counts the transition of the fiber optic beams from a stage of unblocked to blocked. The counter means (26) receives a signal that identifies a beginning to a dispense or counting session, and another signal that identifies the end to a dispense or counting session. The counter means (26) is operable to increment the transitions up to the end of the dispense or counting session so as to arrive at the primary pill count described below.

The primary counting apparatus (25) is also operable to capture the series of transitions or state-data for the sensor array (referred to as “sensor capture data”).

The counter means (26) can be implemented as a high speed leading edge transition counter coupled to the sensor array (28).

In a particular aspect of the invention, the counting means (26) includes or is linked to a computer or some other means of implementing the functions described herein to hardware. The computer can be any manner of computer device such as a micro-computer, or personal computer that is made part of the medication dispensary kiosk and is configured to execute the computer-implemented method described herein. Alternatively, the computer could be a remote computer but connected through a computer network and/or wireless network to the medication dispensary kiosk. The computer is linked to a memory, and the system is operable to store state-data from the sensor array to the memory on dispense by dispense or counting session by counting session basis. Alternatively, no memory is necessary, and a data array can be used that is part of or linked to the counting system (23). Also, the functions of the counting means (26) can be hardwired to an electronic component linked to the counting system (23) such as a microcontroller.

The primary counting apparatus (25) or the primary counting apparatus in combination with the computer is operable to generate a pill count on a dispense by dispense or counting session by counting session basis, and store the results for the pill count in the memory or data array (“primary pill count”).

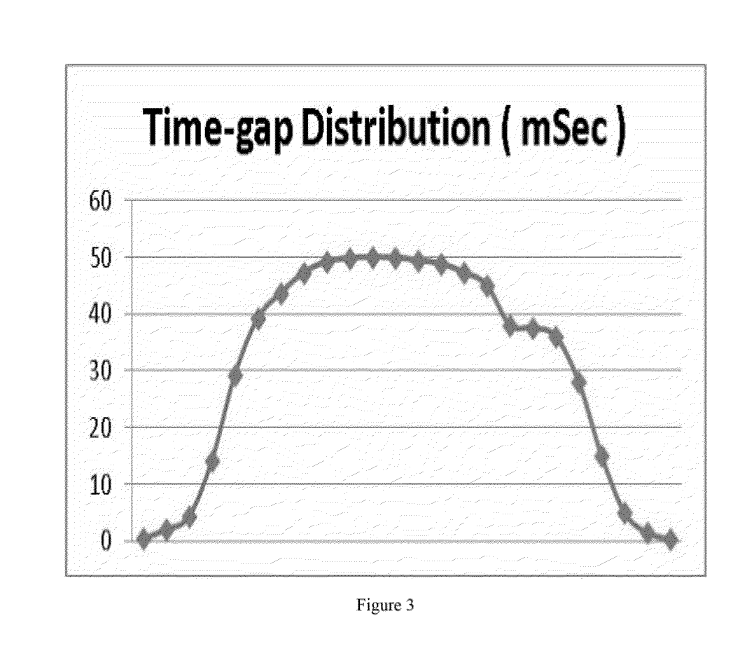

In another aspect of the present invention, the primary counting apparatus (25) is also operable to relate the sensor capture data to a timeline, such that within the time period of the particular dispense or counting session, the stream of pills transported by the pill transport apparatus (17) is analyzed to determine the time gap between each pill entering the pill drop zone, and place each such time gap in the timeline. This provide a time-gap distribution for the particular dispense or counting session, as illustrated in FIG. 3. More significantly, the primary counting apparatus (25) is therefore operable to provide a rising-edge pill count at a rate that is sufficient to control the pill delivery speed.

In one aspect of the invention, the primary counting apparatus (25) interoperates with the control system (21) to implement one or more control routines for controlling the pill transport apparatus (17) in real time or near real time based on the varying speed of the pill delivery. The specifics of the control routines will depend on the design of the pill transport apparatus (17), its current state of operation, the size and weight attributes of the pill being dispensed or counted, and so on. The attributes of the control routines are established, and then selected for application, in order to reduce errors. The control routines may include slowing down the pill transport when the time-gap between pills increases past specific thresholds or decreases below specific thresholds, point or portion of the pill transport sequence for the dispense or counting session.

The system of the present invention, relying on the time-gap data, is operable to balance efficiency with accuracy by selectively controlling, on an automated basis, by operation of the system of the invention, the speed of pill transport to reduce the likelihood of pill counting errors or other problems resulting from pill transport. For example, it is generally advantageous to slow down pill transport nearing the end of the dispense or counting session because the mechanical parts of the pill transport apparatus (17) have momentum and if the dispense or counting session ends abruptly then it is common for errors to occur or for increase wear on the apparatus. In order to slow down the pill transport at the appropriate time, given the variation in the time-gap between any two pills in a stream of pills transported in a given dispense or counting session, the present invention provides more accurate data to the control system (21) as to what point in the dispense or counting session has been reached at a specific time, thereby enabling more effective control of the system to reduce dispense or counting errors or for example avoid other problems such as fragmentation of pills. A representative time gap distribution is illustrated in FIG. 3.

It should be understood that the container delivery apparatus (18) may have moving parts that could affect the accuracy of a dispense or counting session by operation of the present system. Accordingly, the container delivery apparatus (18) may be linked to one or more sensors that are operable to signal to the control system (21) and/or counting system (23) that the container delivery apparatus (18) is in place, or the container is in place, such that the dispense or counting session can begin.

As another example, the time-gap may in a particular dispense or counting session begin to reach a maximum threshold defined by the scan rate of the counting means (26), for example an optical reader used as the primary counting apparatus (25). This may result in more or fewer pills being dropped into the container (16) than are expected to be dropped into the container. If for example the number is smaller than the desired dispense, then the user does not obtain the prescribed quantity of medicament. The error further may cause the medicament dispensary kiosk to dispense medicaments in a manner that is not in accordance with governing regulations.

In accordance with the present invention, the primary counting apparatus (25) is operable to capture the data necessary for the control system (21) to slow down pill transport to avoid reaching such maximum threshold.

### Secondary Counting Apparatus

Achieving marketable dispense or pill counting speed requires relatively rapid pill transport by means of the pill transport apparatus in filling containers with pills from the bulk pill store. In some cases, this can result in pill counting errors if the counting system (23) relies on the primary counting apparatus (25) alone, such as an optical counting device. The incorrect pill counts may result from pill fragments rather than entire pills in the stream of pills transported; blocked sensor beams; dirty sensor beams; noise interfering with the operation of sensors; a saturated amplifier in the optical beam apparatus, and so on.

The counting system (23) or apparatus of the present invention therefore includes a secondary counting system (29) or apparatus. The secondary counting system (29) includes a device that is operable to analyze the sensor capture data on a dispense by dispense or counting session by counting session basis to provide a secondary pill count.

The secondary pill count is established based on off-line examination of the sensor capture data in real time or near real time, by operation of the counting system (23).

The secondary pill count, in a particular aspect of the invention, relies on the sensor capture data related to the primary pill count, but the secondary pill count involves a validation of the primary pill count based on application of statistical analysis. Specifically the secondary pill counting system (29) is operable to apply historical trending to the sensor capture data for validation purposes.

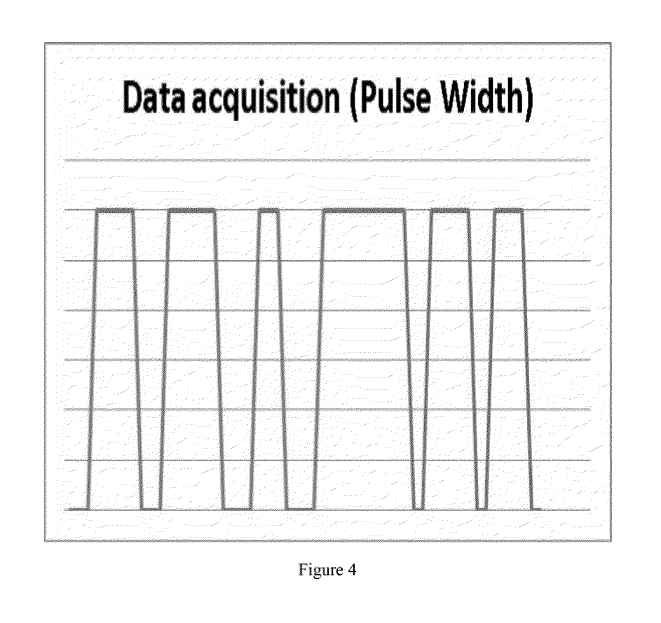

The secondary pill counting system (29), in one implementation thereof, is operable to poll the sensor array within a repeating interval of time. The interval time can be established so that it is less than narrowest time gap between any two pills during pill transport for any dispense or counting session by operation of the pill transport apparatus of the present invention. The secondary pill counting transport system (29) of the present invention, based on the polling of the sensor array is operable to generate a preliminary secondary pill count, and for this preliminary secondary pill count it establishes a pulse-width for each pill in the secondary pill count by capturing the state of the sensor for each reading of a pill passing through the sensor array. A representative illustration of pulse width variation data is shown in FIG. 4.

It should be understood that this secondary pill count in effect constitutes a second pill count for the same dispense or counting session, which occurs at the same time as the primary pill count. This enables the system of present invention to conduct and record two pill counts simultaneously. This is important because two pill counts are often required by drug regulations or other regulations, and prior art technologies generally require two consecutive pill counts to occur, thus decreasing efficiency.

The secondary pill counting system (29) includes or is linked to a statistical analysis utility (31). The statistical analysis utility (31) embodies one or more logical operations that are applied to the preliminary secondary pill count for validation thereof, for example in the manner described below. The statistical utility (31) may be implemented as a computer program, that is made available to a computer associated with the control system (21) and counting system (23) (such as the computer mentioned above), or also can be implemented as one or more electronic components that are part of the system of the present invention.

This pulse width data is then analyzed by operation of the statistical analysis utility (31). The statistical analysis utility (31) embodies a decision tree (33) or other means of pulse width data or the results of the analysis thereof resulting in application of one or more logical operations, and the results of application of such logical operations optionally resulting in application of further logical operations, and so on. Examples of such logical operations are described below.

In a particular aspect of the present invention, the statistical analysis utility (31) may determine whether acceptable upper and lower limits have been reached by the pulse width data based on one or more criteria relevant to accuracy of a pill dispense or count, including for example possible non-singulated pills, possible fragmented pills, possible system noise, and other such criteria. The secondary pill counting system (29) is operable to generate a statistical analysis of the particular dispense or counting session, which can take the form of a table or other data structure that on a pill by pill basis flags pulse width measurements, for example that relative to their placement within the dispense or counting session are indicated as meeting or failing to meet applicable minimum thresholds or maximum thresholds. These thresholds indicate one or more criteria relevant to accuracy of the pill dispense or count. In one aspect of the present invention this results in a preliminary conclusion being reached for each pill by the statistical analysis utility (31) (“preliminary conclusion data”).

In another aspect of the invention, the preliminary conclusions are further analyzed by the statistical analysis utility (31).

The further analysis may include, in one aspect of the invention, an analysis of the reliability of the preliminary conclusion data relative to internal data for the current dispense or counting session. A suitable logical operation can be used to establish a reliability factor of the preliminary conclusion data based on internal data for the dispense or counting session, for example:

Ri(n)=(M/(1+e^{-q}))−k where q=(a*n)−j

Ri: Reliability factor for internal (current) dispense data
n: Sample size of current dispense (number of pills)

### a: Slope

j: x-axis shift constant
M: function value range scaling multiplier
k: y-axis offset constant

In addition, the system is operable to capture external data from past dispenses or counting sessions, whether for a particular medication dispensing kiosk for example, or for several linked medication dispensing kiosks, operable to provide such information to a central server, which is then provided to the particular medication dispensing kiosk, or whether this data is exchanged within a peer-to-peer network of medication dispensing kiosks provided in accordance with known peer-to-peer network configurations.

The preliminary conclusion data can be further analyzed for its reliability relative to such external data using a suitable logical operation, for example:

Re(d)=(M/(1+e^{-q}))−k where q=(a*d)−j

Re: Reliability factor for external (past) dispense data
d: Number of successful past dispenses

### a: Slope

j: x-axis shift constant
M: function value range scaling multiplier
k: y-axis offset constant

In another particular aspect of the statistical utility (31), the statistical utility (31) is operable to combine Ri and Re to derive a minimum reliability constant, Rmin. As a further aspect of the operation of the statistical utility (31), depending on the results of the analysis, one or more control operations can be triggered such as a recount of the dispense or counting session, by sending a signal to the control system (21), or by alerting an operator linked to the system such as a pharmacist in the case of a medicament dispensing kiosk. The pharmacist may then review the tertiary pill count results referred to below and/or order a recount. The escalation processes can be provided as a series of escalation routines embodied in the decision tree (33) and which initiate a control response from the control system (21) on an automated basis.

The internal and external data may be utilized by the statistical facility in combination as follows. (A) If a weighted averaging of the external data supports the internal data analysis and preliminary conclusions, then if a pulse width has been flagged for a broken pill or multiple pills crossing the sensor array together, then the external data validates the internal data, and a course of action is initiated based on an escalation routine embodied in the system of the present invention. (B) Conversely, if for example the sample size for the external data was low, then a low reliability factor is assigned and therefore the weighted averaging of the external data overrules the internal data analysis, which depending on the specific results may lead to escalation of the dispense or pill count.

It should also be understood that the statistical utility (31) contemplates iterative modification of historical trending data. For example if Ri+Re exceeds or is equal to Rmin, then Ri and Re may be used to calculate a weighted average of defined upper or lower limits. These limits can be updated and provided to other linked medicament dispensing kiosks or other system including a pill counting apparatus.

It should be understood that the statistic analysis utility (31) may consider the following factors in a series of possible logical operations: (1) the mean pulse width for the dispense or counting session, based on an average of all of the applicable pulse widths, (2) multiplied by the sample size; (3) the mean pulse width from historical data for the same pill; and (4) the number of dispenses upon which (3) was based. This illustrates the basis for a series of operations for assessing the reliability of the preliminary conclusion data generated by the secondary counting system (29).

Regarding historical trend data, it is contemplated that the operator of the system will collect trend data sets regarding the dispense or counting of specific pills whether using specific pill transport apparatus so as to provide the historical trend data for specific pills. This pill specific information, in this case external information, but also pill specific internal information to the medication dispensing kiosk in question will be accessed from a database based on the drug related data associated with the dispense.

### Tertiary Counting Apparatus

In another embodiment of the invention, a tertiary count is performed by analyzing other data associated with the primary count. One such tertiary count is effected by manual or computer generated analysis of high-speed video frames that record the stream of delivery of pills for the entire dispense or counting session. For this application a high frame speed camera is part of the system, and is disposed to capture video frames of delivery of pills to the pill drop zone for analysis by a computer. An alternative or additional tertiary count is obtained by comparing the before and after weight of the container into which the pills drop in the course of the dispense or counting session.

### Escalation

It should be understood that the analysis by operation of the statistical analysis utility (31) is operable to identify one or more historical trend off-sets that may indicate a number of possible problems either with the pill transport during the particular dispense or counting session, or possibly other problems such as a physical error, increase in temperature, or other condition requiring calibration or maintenance. Medicament dispensary kiosks in particular are complex machines and are required to operate within strict parameters. The secondary counting system (29) provides useful data for the monitoring and maintenance of such machines.

It should be understood that the decision tree (33) mentioned above is operable, based on the results of the operations described, and other similar or related operations embodied in the statistical analysis utility (31), to escalate based on a number of possible different escalation paths (35). For example, depending on the circumstances and results, review of the tertiary video data referred to below could be mandated, or a recount could be mandated, or a decision of which path to take could be delegated to a pharmacist, and so on.

The present invention may therefore facilitate dispensing of pills through an automated dispensary from one or more bulk pill stores, in an accurate manner at a lower cost than traditional pharmacy-based dispensing systems.

The present invention need not be applied to a medicament dispensary kiosk, but can also be used for pill counting devices used in other applications such as in a pharmacy. One of the advantages of the invention that other pill counting technologies generally switching between one counting configuration and another when a change is made as to the drug being dispensed or counted, and this change has an impact on performance of the dispensing/counting because of size, weight, or shape differences between the pills at issue. This sometimes requires manual adjustment of the equipment, or the need to recalibrate the system. The present invention achieves these switches without the need for such time consuming or cumbersome adjustments.

A skilled reader will recognize that additional monitoring means may be applied in the present invention to add additional means of checking the accuracy of the dropping of pills into the container to accurately fill a prescription. In a further embodiment of the invention, error detection sensitivity may be increased by using analog light intensity sensors, the output of the sensors being directly coupled to a micro-controller based control system to analyze light intensity variation with time and to use the light intensity measurement to derive both a primary count and, using appropriate historical reference data, a secondary count.

The counting system (23) may facilitate reporting of the data it collects, such as by way of graphs, charts, text, pulse-width graphics, or other reports. Such reports may be provided to a user for review. The sensor data acquisition facility may further facilitate review of the data it collects. It should be understood that the present invention contemplates use a number of different sensors. Utilities such as the statistical analysis utility can be linked or can be provided such that they embody various analytics processes or technologies, and numerous processes or algorithms that improve the dispense or counting session accuracy. The invention also contemplates the use of distributed computer and data mirroring architectures for updating statistical data, sensor performance data, etc. for a particular medicament dispensing kiosk, or across a network of associated medicament dispensing kiosks.

Other variations and modifications of the invention will be apparent to those skilled in the art. The embodiments of the invention described and illustrated are not intended to be limiting. The principles of the invention contemplate many alternatives having advantages and properties evident in the exemplary embodiments.

1. A method for counting items moving as a closely arranged series thereof, the method comprising directing the items of the closely arranged series past at least one sensor to generate a sequence of energy pulses corresponding to the passage of successive ones of the items past the at least one sensor, analyzing the sequence of pulses to generate a first count, deriving pulse width data from the sequence of pulses, comparing the pulse width data against reference data related to prior valid counts of other items to derive a second count, and determining a valid count exists if the first count matches the second count.

2. A method for the delivery of individually prescribed amounts of one or more pill medicaments from a pill dispenser comprising of the steps of:
a. receiving input by the pill dispenser regarding desired pill types and quantities;
b. allowing a control system to determine logic requirements for the dispensing of pills;
c. delivering of pills to a pill singulator, comprising of:
i. a tray for supporting pills;
ii. a drive means that is operable to move the pills in a stream that is of one pill in width; and
iii. a guide to guide to establish spacing between the driven pills and to guide the driven pills into a container;
d. counting the number of pills being driven into the container by gathering sensor data from at least one sensor disposed adjacent to the opening of the container, and analyzing such sensor data so as to establish a primary pill count and a secondary validated pill count derived from the pill count; and
e. authorizing dispensing of the one or more pills to the user if the analysis of the sensor data generates a successful comparison result between the desired pill quantity and the primary pill count and the secondary validated pill count.

3. The method of claim 2, wherein the counting of the number of pills includes incrementing a series of sensor transitions acquired from the at least one sensor.

4. The method of claim 2, comprising the further steps of providing the sensor transitions to a memory store or data array and thereby defining the primary pill count.

5. The method of claim 4, comprising the further steps of relating the primary pill count to a timeline for a pill dispense, and generating time-gap data for the pill dispense based on the time-gap between any two consecutive pills being driven to the opening of the container.

6. The method of claim 5, comprising the further step of feeding back the time-gap data to the control system in real time or near real time to enable the control of the operation of the pill singulator to reduce pill counting errors or other pill driving operational errors.

7. The method of claim 6, comprising validating the primary pill count by capturing secondary sensor data, and analyzing the primary pill count based on such analysis.

8. The method of claim 7, comprising analyzing the secondary sensor data based on a statistical analysis thereof.

9. The method of claim 8, comprising accessing one or more of a plurality of logical functions that embody or form part of a decision tree, for directing the application of the statistical analysis to the particular primary pill count and secondary sensor data.

10. The method of claim 9, comprising the step of feeding the results of the statistical analysis to the control system.

11. The method of claim 10, comprising the step of escalating the results of the statistical analysis by operation of the control system, such escalation including one or more of (i) engaging a pharmacist, (ii) engaging a tertiary pill counting apparatus or method for validating the secondary sensor data, (iii) mandating a recount for the dispense, or (iv) requiring corrective action for the pill dispenser.

12. A system for counting items, the system comprising a drive to move the items as a closely arranged series, at least one sensor to detect passage of the items past the at least one sensor and for generating a sequence of energy pulses corresponding to the passage of successive ones of the items past the at least one sensor, an analysis module to analyze the sequence of pulses to generate a first count, to derive pulse width data from the sequence of pulses, to compare the pulse width data against reference data related to prior valid counts of other items to derive a second count, and to determine a valid count exists if the first count matches the second count.

13. A system for the delivery of individually prescribed amounts of one or more pill medicaments from a pill dispenser comprising:
a. a pill singulator, comprising of:
i. a tray for supporting pills;
ii. a drive means that is operable to move the pills in a stream that is of one pill in width; and
iii. a guide to guide the driven pills towards a pill receiving station and to establish spacing between the driven pills;
and being operable to transfer the pills to a pill container;
b. a control system linked to the pill singulator for controlling the driving of pills by the pill singulator, including controlling the starting and stopping of the pill singulator, and the speed of the driving of pills by the pill singulator, and for determining the logic requirements for the dispensing of pills, including based on desired pill types and quantities; and
c. a counting system linked to the control system, for counting the number of pills being driven into the container by gathering sensor data from at least one sensor disposed adjacent to the opening of the container, and analyzing such sensor data so as to establish a primary pill count and a secondary validated pill count derived from the primary pill count;
wherein the control system authorizes the dispensing of the one or more pills to the user if the analysis of the sensor data generates a successful comparison result between the desired pill quantity and the primary pill count and the secondary validated pill count.

14. The system of claim 13, wherein the counting system is operable to generate the primary pill count by incrementing a series of sensor transitions acquired from the at least one sensor.

15. The system of claim 14, wherein the counting system is operable to provide the sensor transitions to a memory store or data array and thereby defining the primary pill count.

16. The system of claim 15, wherein the counting system is operable to relate the primary pill count to a timeline for a pill dispense, and generate time-gap data for the pill dispense based on the time-gap between any two consecutive pills being driven to the opening of the container.

17. The system of claim 16, wherein the counting system is further operable to feed back the time-gap data to the control system in real time or near real time to enable the control of the operation of the pill singulator to reduce pill counting errors or other pill driving operational errors.

18. The system of claim 13, wherein the counting system is further operable to validate the primary pill count by operation of a secondary pill counter.

19. The system of claim 18, wherein the counting system is operable to validate the primary pill count by capturing secondary sensor data, and analyzing the primary pill count based on such analysis.

20. The system of claim 19, wherein the counting system is operable to analyze the secondary sensor data based on a statistical analysis thereof.

21. The system of claim 20, wherein the counting system is operable to apply one or more of a plurality of logical functions that embody or form part of a decision tree, for directing the application of the statistical analysis to the particular primary pill count and secondary sensor data.

22. The system of claim 21, wherein the counting system feeds the results of the statistical analysis to the control system.

23. The method of claim 22, wherein the counting system is control system is operable to escalate the results of the statistical analysis, such escalation including one or more of (i) engaging a pharmacist, (ii) engaging a tertiary pill counting apparatus or method for validating the secondary sensor data, (iii) mandating a recount for the dispense, or (iv) requiring corrective action for the pill dispenser.
